(19) United States
(12) Patent Application Publication
(10) Pub. No.: US 2026/0229403 A1
(43) Pub. Date: Aug. 6, 2026

(54) METHOD FOR MANUFACTURING DUST CORE

(71) Applicant: Panasonic Intellectual Property Management Co., Ltd., Osaka (JP)

(72) Inventors: TORU IWABUCHI, Kyoto (JP); KAZUKI NOGUCHI, Osaka (JP); HITOSHI HORIUCHI, Osaka (JP)

(21) Appl. No.: 19/152,965

(22) PCT Filed: Jan. 16, 2024
(86) PCT No.: PCT/JP2024/000957

§ 371 Date: Aug. 1, 2025

(30) Foreign Application Priority Data
Feb. 22, 2023 (JP) 2023-026085

(51) Int. Cl. H01F 41/02; B22F 1/103; B22F 1/142; B22F 3/03; C22C 38/02; C22C 38/06; C22C 38/34; H01F 27/255

(52) U.S. Cl. CPC H01F 41/0246; B22F 1/103; B22F 1/142; B22F 3/03; C22C 38/02; C22C 38/06; C22C 38/34; H01F 27/255

(57) ABSTRACT

The method for manufacturing a dust core includes a first step of mixing a metal magnetic powder, a resin, and a metal soap to obtain a granular granulated powder, the metal magnetic powder including a plurality of metal magnetic particles, and a second step of pressure-molding the granular granulated powder to obtain a molded body. The metal soap is liquid state at 25° C. and contains Si element.

### TECHNICAL FIELD

The present disclosure relates to a method for manufacturing a dust core.

### BACKGROUND ART

Conventionally, oxide magnetic materials such as ferrite and metal magnetic materials have been used as magnetic materials for magnetic cores of inductors and transformers. As a magnetic core using these magnetic materials, for example, there is a dust core obtained by compression-molding metal magnetic powder. Such a dust core has a high saturation magnetic flux density and is advantageous for reducing the size of components such as inductors and transformers. In addition, since the dust core can be molded using a die, the degree of freedom of the shape of the magnetic core is high, and even if the shape is complicated, the dust core can be manufactured with high accuracy by a simple process. Therefore, their usefulness has attracted attention.

For example, Patent Literature 1 discloses a molding material including a metal magnetic powder surface-treated with a silane-based coupling agent or a titanium-based coupling agent, and a resin. The metal magnetic powder surface-treated with the coupling agent improves the fluidity of the molding material. When the fluidity of the molding material is improved, the filling factor of the molded body can be enhanced, and thus a dust core having excellent magnetic properties is easily formed.

### CITATION LIST

### Patent Literature

Patent Literature 1: Japanese Unexamined Patent Application No. 2018-135416

### SUMMARY OF THE INVENTION

When a metal magnetic powder is used as the magnetic powder in the dust core, it is required to enhance the insulation properties between the particles of the metal magnetic powder in order to suppress breakage or the like of the dust core. However, in the dust core, when the filling factor of the metal magnetic powder is increased in order to improve the magnetic properties, the gap between the particles of the metal magnetic powder is reduced, and thus the insulation properties are likely to be reduced.

An object of the present disclosure is to provide a method for manufacturing a dust core with improved insulation properties.

A method for manufacturing a dust core according to an aspect of the present disclosure comprises: mixing a metal magnetic powder, a resin, and a metal soap to obtain a granular granulated powder, the metal magnetic powder including a plurality of metal magnetic particles; and pressure-molding the granular granulated powder obtained. The metal soap is in a liquid state at 25° C. and includes a Si element.

According to the present disclosure, the insulation properties of the dust core is improved.

### BRIEF DESCRIPTION OF THE DRAWINGS

FIG. 1 is a schematic perspective view showing a configuration of an electrical component including a dust core according to an embodiment.

FIG. 2 is a diagram schematically showing a cross section of the dust core according to the embodiment.

FIG. 3 is a flowchart showing a method for manufacturing the dust core according to the embodiment.

FIG. 4 is a flowchart showing a process of preparing granulated powder according to the embodiment.

FIG. 5 is a diagram showing a relationship between a breakdown voltage and a magnetic permeability in a sample of a dust core.

FIG. 6 is a diagram showing a relationship between a breakdown voltage and a magnetic permeability in a sample of a dust core.

### DESCRIPTION OF EMBODIMENT

Hereinafter, embodiments of the present disclosure will be specifically described with reference to the drawings.

It is to be noted that each of the embodiments described below illustrates a specific example of the present disclosure. The numerical values, shapes, materials, constituent elements, the arrangement and connection of the constituent elements, steps (processes), the processing order of the steps (processes), etc. illustrated in the following embodiments are mere examples, and are not intended to limit the present disclosure. Further, among the constituent elements in the following embodiments, below, constituent elements not recited in any one of the independent claims will be described as optional constituent elements.

The drawings are represented schematically and are not necessarily precise illustrations. Therefore, for example, scales are not necessarily consistent from drawing to drawing. In the drawings, essentially the same constituent elements share the same reference signs, and redundant description will be omitted or simplified.

In addition, in the present specification, terms indicating a relationship between elements such as “parallel” and “orthogonal”, terms indicating the shape of elements such as “rectangular” and “rectangular parallelepiped”, and numerical value range do not represent there strict meanings only but also include substantially equivalent range, e.g., difference of about several percent.

### Embodiment

Hereinafter, a dust core according to an embodiment and an electrical component using the dust core will be described.

### [Configuration]

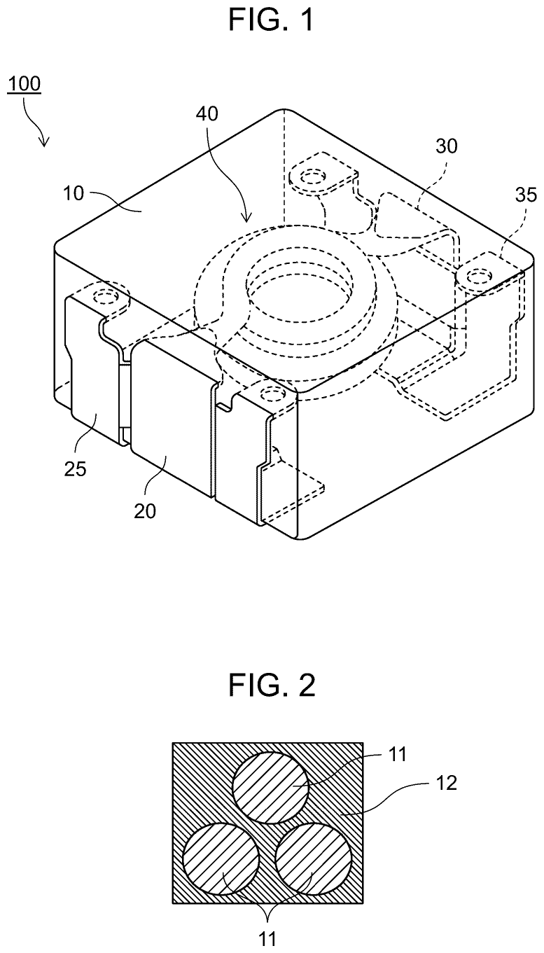

First, a configuration of an electrical component using a dust core according to an embodiment will be described with reference to FIG. 1 and FIG. 2.

FIG. 1 is a schematic perspective view showing a configuration of an electrical component including a dust core according to an embodiment. FIG. 1 shows an outline of dust core 10 described later, and further shows the inside of dust core 10 in a transparent manner. For example, constituent elements invisible by being embedded in dust core 10, such as coil member 40, are illustrated with broken lines to show that such constituent elements are seen through dust core 10.

As shown in FIG. 1, electrical component 100 includes dust core 10, coil member 40, first terminal member 25, and second terminal member 35.

Electrical component 100 is, for example, an inductor having a rectangular parallelepiped shape, and a rough profile of electrical component 100 is determined by the shape of dust core 10. Note that dust core 10 can be formed into any shape by pressure molding. That is to say, any shape of electrical component 100 can be achieved by the shaping dust core 10 through pressure molding. Therefore, the shape of the dust core is not limited to a rectangular parallelepiped shape and may be a different shape.

Electrical component 100 is a passive element that stores electric energy flowing between first terminal member 25 and second terminal member 35 as magnetic energy by coil member 40. In the present embodiment, electrical component 100 will be described as an example of use of dust core 10. Dust core 10 can be used simply as a magnetic material, and the use example is not limited to electrical component 100 according to the present embodiment.

Dust core 10 has substantially quadrangular prism shape having rectangular opposing surfaces on which first terminal member 25 and second terminal member 35 are formed. The respective four sides of the opposing surfaces are connected by a top surface, a bottom surface, and two side surfaces. In the present embodiment, dust core 10 has, for example, a rectangular shape in which the bottom surface and the top surface have dimensions of about 14.0 mm×12.5 mm, and the separation distance from the bottom surface to the top surface is about 8.0 mm.

FIG. 2 is a diagram schematically showing a cross section of dust core 10. FIG. 2 is an enlarged view of a part of the cross section of dust core 10.

As shown in FIG. 2, dust core 10 includes: a metal magnetic powder 11 including a plurality of metal magnetic particles; and binding agent 12 that binds the plurality of metal magnetic particles of metal magnetic powder 11 to each other.

As metal magnetic powder 11, Fe—Si—Al based, Fe—Si based, Fe—Si—Cr based, or Fe—Si—Cr—B based, or the like metal magnetic powder is used. Metal magnetic powder 11 has a high saturation magnetic flux density as compared to magnetic powders such as ferrite, thus being useful for use under a high current.

In the case of using an Fe—Si—Al based metal magnetic powder, for example, the composition elements include Si with a content of 8 wt % or more and 12 wt % or less, Al with a content of 4 wt % or more and 6 wt % or less, and the remaining composition elements including Fe and inevitable impurities. Here, examples of the inevitable impurities include Mn, Ni, P, S, and C, and the like. A high magnetic permeability and a low coercive force can be obtained by setting the content of the composition elements composing metal magnetic powder 11 to the above-mentioned composition ranges. In the case of using an Fe—Si-based metal magnetic powder, for example, the composition elements include Si with a content of 1 wt % or more and 8 wt % or less, and the remaining composition elements including Fe and inevitable impurities. Note that the inevitable impurities are the same as those described above.

In the case of using an Fe—Si—Cr-based metal magnetic powder, for example, the composition elements include Si with a content of 1 wt % or more and 8 wt % or less, Cr with a content of 2 wt % or more and 8 wt % or less, and the remaining composition elements including Fe and inevitable impurities. Note that the inevitable impurities are the same as those described above.

In the case of using an Fe—Si—Cr—B-based metal magnetic powder, for example, the composition elements include Si with a content of 1 wt % or more and 8 wt % or less, Cr with a content of 2 wt % or more and 8 wt % or less, B with a content of 1 wt % or more and 8 wt % or less, and the remaining composition elements including Fe and inevitable impurities. Note that the inevitable impurities are the same as those described above.

A role of Si in the composition elements of the above-mentioned metal magnetic powder 11 is to impart an effect of reducing eddy current loss by reducing magnetic anisotropy and a magnetostriction constant, and by increasing the electric resistance. By setting the content of Si in the composition elements is 1 wt % or more, it is possible to obtain an effect of improving soft magnetic properties. In addition, by setting the content of Si in the composition elements to 8 wt % or less, it is possible to suppress a decrease in DC saturation characteristics by suppressing a decrease in saturation magnetization.

By causing metal magnetic powder 11 to contain Cr, it is possible to impart an effect of enhancing weatherability. By setting the content of Cr in the composition elements to 2 wt % or more, it is possible to obtain an effect of improving weatherability. By setting the content of Cr in the composition elements to 8 wt % or less, it is possible to suppress deterioration of soft magnetic properties.

The method for producing metal magnetic powder 11 according to the present embodiment is not particularly limited, and various atomization methods and various pulverization methods can be used.

The median diameter D50 of metal magnetic powder 11 is, for example, at least 1.0 μm and at most 35 μm. By setting median diameter D50 of metal magnetic powder 11 to be small, electric field concentration between particles can be relaxed, and insulation properties can be ensured. In addition, by setting the median diameter D50 as above it is possible to ensure a high filling factor and handleability can be ensured. Further, by setting median diameter D50 of metal magnetic powder 11 to 35 μm or less, it is possible to reduce a core loss, particularly, an eddy current loss, in a high frequency region. Median diameter D50 of metal magnetic powder 11 is the particle diameter at which, when a count is started from a particle having a smaller particle diameter by using a particle size distribution meter that performs measurement with a laser diffraction scattering method, the integrated value reaches 50% of the whole.

Binding agent 12 is provided to cover the periphery of the metal magnetic particles of metal magnetic powder 11. Binding agent 12 is located between the metal magnetic particles of metal magnetic powder 11. Binding agent 12 is an insulating resin material containing a resin as a main component. Binding agent 12 includes a resin and a metal soap, for example. Binding agent 12 may further include a coupling agent and/or insulating particles (for example, inorganic particles such as talc particles).

The resin is, for example, a thermosetting resin. Examples of the thermosetting resin include an epoxy resin, a phenol resin, a silicone resin, and a polyimide resin, for example. The resin may also be a thermoplastic resin. Examples of the thermoplastic resin include an acrylic resin, polyethylene, polypropylene, and polystyrene, for example. Binding agent 12 may include a plurality of kinds of resins.

Binding agent 12 may include a Si element derived from the metal soap. Binding agent 12 includes, for example, a metal soap including the Si element and/or a reaction product of a metal soap including the Si element as the constituent including the Si element.

In dust core 10, a coating derived from the metal soap including the Si element may be included between the metal magnetic particles of metal magnetic powder 11 and binding agent 12. The coating film is included so as to cover the entire surface of the metal magnetic particles of metal magnetic powder 11, for example.

Subsequently, coil member 40, first terminal member 25 and second terminal member 35 will be described with reference to FIG. 1.

Coil member 40 includes a wound portion around which a conductive wire that is an elongated conductor covered by an insulating film is wound, and lead portion 20 and lead portion 30 in which two ends of the conductive wire are connected to the first terminal member 25 and the second terminal member 35, respectively. In the present embodiment, it is assumed that a round conductive wire having a cross-sectional diameter of about 0.65 mm is used as the conductive wire. The thickness and shape of the conductive wire are not particularly limited. As long as the conducting wire is thick enough to allow winding processing etc., a flat rectangular conducting wire having a rectangular cross section, a round conducting wire, and so on can be selected and used as appropriate. The wound portion is embedded in the vicinity of the center of the dust core 10. In addition, in lead portion 20 and lead portion 30, each of the two ends of the conductive wire continuously extend from the wound portion to a corresponding one of the opposing surface, and protrude to outward from dust core 10. Here, a part of lead portion 20 and a part of lead portion 30 are extended to form a flat shape, and are bent along the corresponding one of the opposing surface and the bottom surface. At the extended part, the insulating film cover is removed to allow electrical connection to the outside.

First terminal member 25 and second terminal member 35 are conductor plate made of, for example, a phosphor bronze material or a copper material. Each of first terminal member 25 and second terminal member 35 has a recess in the vicinity of its center along a corresponding one of the opposing surface and is recessed into dust core 10. Lead portion 20 and lead portion 30 are provided outside the recess. Lead portion 20 and first terminal member 25 are electrically connected to each other. Lead portion 30 and second terminal member 35 are electrically connected to each other. Lead portion 20 and lead portion 30 are connected to first terminal member 25 and second terminal member 35, respectively, by resistance welding or the like. First terminal member 25 and second terminal member 35 are bent to be inserted into the inside of dust core 10, and first terminal member 25 and second terminal member 35 are fixed to dust core 10 in a state where the bent portions are inserted into dust core 10.

First terminal member 25 and second terminal member 35 are bent along the bottom surface of dust core 10 together with lead portion 20 and lead portion 30. As a result, lead portion 20 and lead portion 30 are held by first terminal member 25 and second terminal member 35, and are disposed on the bottom lower side of electrical component 100. That is to say, lead portion 20 and lead portion 30 can be directly connected to a land (not shown) of a mounting substrate or the like on which electrical component 100 is mounted.

Note that first terminal member 25 and second terminal member 35 are not essential constituent components. First terminal member 25 and second terminal member 35 need not be included if lead portions 20 and 30 are strong enough to maintain their shape by themselves.

### [Manufacturing Method]

Next, an example of a method for manufacturing above-described dust core 10 will be described.

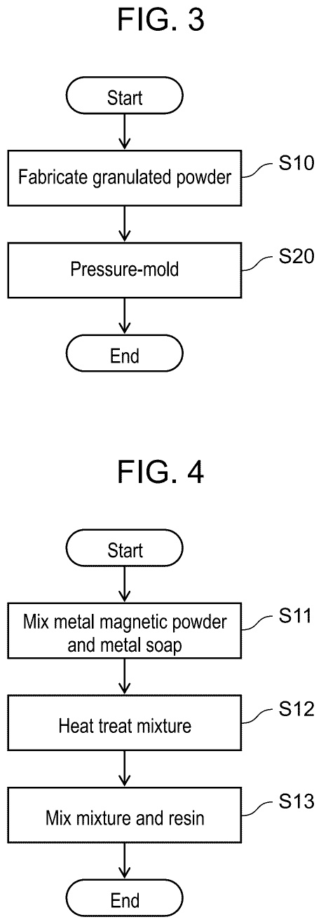

FIG. 3 is a flowchart showing a method for manufacturing the dust core according to the present embodiment.

As shown in FIG. 3, in the method for manufacturing dust core 10 according to the present embodiment, first, metal magnetic powder 11, a resin, and a metal soap are mixed to fabricate granular granulated powder in which metal magnetic powder 11, the resin, and the metal soap are mixed (step S10). Step S10 is an example of a first step. In step S10, for example, metal magnetic powder 11 and a metal soap are mixed to obtain a mixture, and then the mixture and a resin are mixed to obtain a granulated powder.

FIG. 4 is a flowchart showing a process of preparing granulated powder according to the present embodiment. In step S10, granulated powder is obtained by performing each step (step) shown in FIG. 4.

As shown in FIG. 4, in the fabrication of the granulated powder, first, metal magnetic powder 11 and a metal soap are mixed (step S11). In this way, a mixture of metal magnetic powder 11 and the metal soap is obtained. In step S11, the mixture contains substantially no resin. The mixing in step S11 is performed, for example, at room temperature of about 25° C. without particularly performing temperature control such as heating and cooling. When the ambient temperature is low, the metal soap may be heated to a temperature of about 40° C. or lower and mixed in order to maintain the metal soap in a liquid state.

The metal soap includes the Si element. Specifically, the metal soap is fatty acid silicon. The metal soap to be mixed is liquid at 25° C. (normal temperature). That is, the melting point of the metal soap is lower than 25° C. Therefore, in step S11, metal magnetic powder 11 is mixed with the metal soap in a liquid state. The metal soap on a liquid state has a branch in the hydrocarbon chain of the fatty acid, in order to decrease the melting point. Metal soaps are manufactured in a direct method or double decomposition method, for example. The direct method is a method of directly reacting a fatty acid with a metal oxide or a metal hydroxide. The double decomposition method is a method in which a fatty acid is reacted with a basic compound in an aqueous solution state to obtain a basic compound of the fatty acid, and the basic compound is further reacted with a metal salt containing a metal or a semimetal.

As described above, by mixing metal magnetic powder 11 and the metal soap in a liquid state before mixing the resin, the surface of the metal magnetic particles of metal magnetic powder 11 and the hydrophilic portion of the metal soap easily interact with each other, and the metal soap can effectively work. In addition, since the metal soap is in a liquid state, dispersibility is high, and the metal soap easily acts uniformly on the surfaces of the metal magnetic particles of metal magnetic powder 11.

In step S11, in order to facilitate mixing of metal magnetic powder 11 and the metal soap, a solvent may be further added and mixed. When the solvent is added, the solvent is evaporated by heating at a temperature of, for example, 65° C. or more and 150° C. or less after mixing, and the solvent is removed from the mixture. As the solvent, for example, toluene, xylene, ethanol, isopropyl alcohol, acetone, methyl ethyl ketone, or the like is used.

Next, the mixture of metal magnetic powder 11 and the metal soap obtained in step S11 is subjected to heat treatment (step S12). By such heat treatment, a strong coating derived from the metal soap is formed on the surface of the metal magnetic particles of metal magnetic powder 11. The heating method is not particularly limited, and the heating is performed using, for example, a heating furnace such as an electric furnace. When the mixture is heated to remove the solvent in step S11, the heat treatment may be performed continuously with the removal of the solvent.

The heat treatment in step S12 is performed under a temperature condition of, for example, 200° C. or more and 800° C. or less. Accordingly, the heat treatment is performed at a temperature higher than the curing temperature of the resin and at a temperature at which sintering of metal magnetic powder 11 is less likely to occur, and thus a coating film derived from the metal soap can be effectively formed. From the viewpoint of enhancing the work of the coating derived from the metal soap, the temperature condition of the heat treatment may be 400° C. or more and 600° C. or less. The time of the heat treatment (the time of treatment at the target temperature) is, for example, 20 minutes or more and 120 minutes or less.

In step S12, for example, the heat treatment of the mixture is performed in a non-oxidizing atmosphere such as nitrogen gas. As a result, deterioration due to oxidation of the mixture is suppressed.

As described above, in the fabrication of the granulated powder, after the mixture is obtained, the mixture is subjected to the heat treatment before the mixture and the resin are mixed.

Next, a resin is further added to the mixture subjected to the heat treatment in step S12, and the mixture and the resin are mixed (step S13). Thus, granular granulated powder in which metal magnetic powder 11, the resin, and the metal soap are mixed is obtained. The mixing in step S13 is performed, for example, at room temperature of about 25° C. without particularly performing temperature control such as heating and cooling.

The resin mixed in step S13 is dissolved in a solvent in advance, for example. The resin mixed in step S13 may not be dissolved in the solvent. As the solvent, for example, those exemplified as the solvent used in step S11 described above are used. The resin is a resin serving as a main component of binding agent 12 described above. In step S13, two or more kinds of resins may be mixed.

In step S13, after the mixture subjected to the heat treatment in step S12 and the resin are mixed, the solvent is evaporated by heating at a temperature of, for example, 65° C. or more and 150° C. or less, and the mixture after the solvent evaporation is pulverized to obtain granular granulated powder (composite magnetic material) having high moldability. Further, the granulated powder may be classified to obtain a granulated powder having a particle size within a predetermined range. Accordingly, the moldability can be further improved.

The mixing in step S11 and step S13 is performed using, for example, a mortar, a mixer, a ball mill, a V-type mixer, a cross rotary, or the like.

In step S11 and/or step S13, other materials such as a coupling agent may be further added and mixed as necessary. The other material may contain insulating particles.

Through the above steps, in the fabrication of the granulated powder, metal magnetic powder 11, the resin, and the metal soap are mixed to obtain the granular granulated powder in which metal magnetic powder 11, the resin, and the metal soap are mixed. It can also be said that the obtained granulated powder is a granulated powder including metal magnetic powder 11 and binding agent 12 described above.

In the fabrication of the granulated powder, the mixing ratio of the metal soap to metal magnetic powder 11 (that is, the ratio of the addition amount of the metal soap to the addition amount of the metal magnetic powder 11) is, for example, 0.25 wt % or less. This can effectively improve the magnetic properties and insulating properties of dust core 10. From the viewpoint of further improving the magnetic properties and insulating properties of dust core 10, the mixing ratio of the metal soap may be at least 0.01 wt % and at most 0.25 wt %, or may be at least 0.025 wt % and at most 0.25 wt %.

In the fabrication of the granulated powder, the mixing ratio of the resin to metal magnetic powder 11 (that is, the ratio of the addition amount of the resin to the addition amount of metal magnetic powder 11) is, for example, at least 1 wt % and at most 10 wt %.

In step S13, the granulated powder may be obtained by mixing the resin with the mixture of metal magnetic powder 11 and the metal soap, which is not subjected to the heat treatment without performing step S12.

In the above description, metal magnetic powder 11, the resin, and the metal soap are mixed separately in step S11 and step S13. However, the present invention is not limited thereto. The order of mixing metal magnetic powder 11, the resin, and the metallic soap may be different from the order described above, as far as a granular granulated powder including a mixture of metal magnetic powder 11, the resin, and the metallic soap. For example, metal magnetic powder 11, the resin, and the metal soap may be mixed at same time. Further, a combination of materials different from the above may be mixed in two or more steps.

Referring to FIG. 3 again, after step S10, the granulated powder obtained in step S10 is put into a die and press-molded into a desired shape to obtain the dust core 10 (step S20). Step S20 is an example of a second step. In step S20, for example, pressure molding is performed at a pressure in a range of 3 tons/cm² or more and 7 tons/cm² or less. In addition, a hardening treatment is performed on the pressed dust core 10 by, for example, heating. The conditions of the hardening treatment are set according to the kinds of resin used.

Through the above steps, dust core 10 is produced. Prepared dust core 10 is used as a part of the electrical component 100 in which a coil is embedded. In step S20, the granulated powder may be pressure-molded together with the coil member 40.

As described above, the method for manufacturing dust core 10 includes a first step (step S10) of mixing metal magnetic powder 11, a resin, and a metal soap to obtain a granular granulated powder, and a second step (step S20) of pressure-molding the obtained granulated powder to obtain a molded body. The metal soap is liquid at 25° C. and contains Si element.

Thus, in the process of manufacturing dust core 10, the liquid metal soap including the Si element covers the surfaces of the metal magnetic particles of metal magnetic powder 11. As a result, the metal soap including the Si element protects the metal magnetic particles by, for example, forming a coating film on the surfaces of the metal magnetic particles of metal magnetic powder 11. Therefore, the metal magnetic particles are less likely to come into contact with each other, and the insulation properties of the dust core are improved. Therefore, the method for manufacturing dust core 10 according to the present embodiment can improve the insulation properties of dust core 10. In addition, since the affinity between metal magnetic powder 11 and the resin is improved by the metal soap, the gap between the metal magnetic particles of metal magnetic powder 11 is likely to be reduced in pressure molding, and the magnetic characteristics of dust core 10 can be improved.

### [Evaluation of Dust Core]

Next, evaluation results of the dust core according to the embodiment will be described. Specifically, a dust core was fabricated as described below, and analysis and characteristics evaluation of the fabricated dust core were evaluated. Note that the present embodiment is not limited to the evaluation described below in any sense.

### <Fabrication of Dust Core>

First, fabrication of a sample of the dust core used for evaluation will be described.

In the preparation of the samples used for the evaluation, first, a metal magnetic powder, a resin, and a Si-based additive were prepared.

As the metal magnetic powder, the metal magnetic powder (Fe—Si—Cr-based metal magnetic powder or Fe—Si-based metal magnetic powder) shown in Tables 1 and Table 2 below was used.

As the resin, a modified silicone resin having a methyl group and a phenyl group in a side chain dissolved in a solvent (isopropyl alcohol) in advance (concentration: 50%) was used. The addition amount of the resin with respect to the addition amount of the metal magnetic powder was set to the addition amount (wt %) shown in Tables 1 and Table 2. Note that the addition amount of the resin is an addition amount by weight excluding the solvent.

As the Si-based additive, a metal soap including a Si element (hereinafter, also referred to as “Si-containing metal soap”) or a silane-based coupling agent was used. As the Si-containing metal soap, silicon fatty acid which is liquid at 25° C. and has a branched hydrocarbon chain was used. For the silane coupling agent used was liquid at 25° C. The addition amount of the Si-based additive with respect to the addition amount of the magnetic metal powder was set to the addition amount (wt %) shown in Tables 1 and Table 2. As shown in Table 1, the Si-based additive was not added to some samples.

Using these materials, first, the magnetic metal powder, the liquid Si-based additive, and toluene were mixed. Thereafter, toluene was removed by heating at 90° C. for 90 minutes to obtain a mixture of the metal magnetic powder and the Si-based additive. Then, the mixture was heat-treated for 30 minutes under the temperature conditions shown in Table 2. The heat treatment was performed under nitrogen gas. For the samples shown in Table 1, only removal of toluene was performed, and heat treatment was not performed. Next, a resin was further added to and mixed with the mixture, and then the mixture was heated to remove the solvent and pulverized to fabricate a granular granulated powder. That is, the granulated powder was fabricated by the method described above with reference to FIG. 4.

The fabricated granulated powder was subjected to pressure molding at room temperature under a pressure of 4 ton/cm² to prepare a ring core having an outer diameter of 14.4 mm, an inner diameter of 10.3 mm, and a thickness of 4.4 mm for evaluation of magnetic permeability. Further, the ring core was dried for 2 hours under a temperature condition of 150° C. to cure the resin, thereby fabricating a ring-shaped dust core sample.

In addition, the fabricated granulated powder was subjected to pressure molding at room temperature under a pressure of 4 ton/cm² to prepare a plate-shaped molded body having a length of 12 mm, a width of 12 mm, and a thickness of 0.70 mm for evaluation of breakdown voltage. Further, the plate-shaped molded body was dried for 2 hours under a temperature condition of 150° C. to cure the resin, thereby fabricating a plate-shaped dust core sample.

### <Method of Calculating Magnetic Permeability>

The magnetic permeability was obtained by measuring the inductance L of the ring-shaped dust core at an applied magnetic field of 0 oersted (Oe) using an LCR meter, and calculating the initial magnetic permeability (the following magnetic permeability μi) from the following formula (1) (at a measurement frequency: 100 kHz). A high magnetic permeability μi indicates that the magnetic properties of the dust core are good.

$$μ i = ( L \times le ) / ( μ 0 \times A e \times {n}^{2 )} \qquad ( 1 )$$

Note that 1e represents the effective magnetic path length, μ0 represents the vacuum magnetic permeability, Ae represents the cross-sectional area, and n represents the number of turns of the measurement coil.

### <Evaluation Method of Breakdown Voltage>

In the measurement of the breakdown voltage serving as an index of insulation properties, a sample of the prepared plate-shaped dust core was sandwiched between conductive rubbers disposed on both main surfaces, a DC voltage having an initial value of 10 V was applied, and thereafter, the applied voltage value was continuously increased at a pace of 5 V/min, and a value (V/mm) obtained by dividing the applied voltage value immediately before dielectric breakdown by the thickness of the molded body was defined as the breakdown voltage value of each dust core. A higher value of breakdown voltage value of dust core indicates higher insulation properties.

### Evaluation Result 1

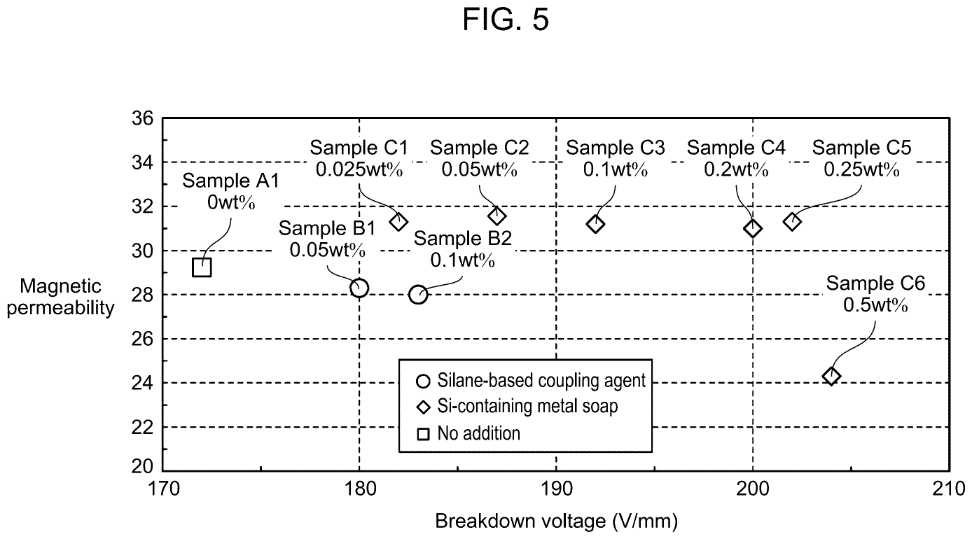

First, with reference to Table 1 and FIG. 5, a description will be given of the results of evaluating of magnetic properties and the insulation properties by changing the kinds of Si-based additive used in the production of the granulated powder and the addition amount of the Si-based additive.

Table 1 shows the types of the metal magnetic powder, the addition amount of the resin, the kinds and addition amount of the Si-based additive, the magnetic permeability, and the breakdown voltage of each of the dust core samples used for the evaluation. FIG. 5 is a diagram showing the relationship between the breakdown voltage and the magnetic permeability in the samples shown in Table 1. That is, FIG. 5 is a graph of the data of Table 1. In FIG. 5, the vertical axis represents the magnetic permeability, and the horizontal axis represents the breakdown voltage. Therefore, in FIG. 5, it can be seen that the samples plotted on the upper right are samples that can achieve both magnetic characteristics and insulation properties. In addition, in FIG. 5, the evaluation result of the sample Al in which the Si-based additive was not used (“No addition” in the legend in the figure), the evaluation results of the samples B1 and B2 in which only the silane-based coupling agent was used as the Si-based additive (“Silane-based coupling agent” in the legend in the figure), and the evaluation results of the samples C1 to C6 in which only the Si-containing metal soap was used (“Si-containing metal soap” in the legend in the figure) are indicated by markers having shapes different from each other. Each marker is labeled with the identification code of the sample and the addition amount of the Si-based additive.

TABLE 1

| | | | Addition amount of | | | |
|---|---|---|---|---|---|---|
| | | Addition | Si-based additive | | | |
| | Metal | amount | (wt %) | | | Breakdown |
| | magnetic | of resin | Si-containing | Silane-based | Magnetic | voltage |
| Sample | powder | (wt %) | metal soap | coupling agent | permeability | (V/mm) |
| A1 | Fe—Si—Cr | 2.5 | 0 | 0 | 29.2 | 172 |
| B1 | Fe—Si—Cr | 2.5 | 0 | 0.050 | 28.3 | 180 |
| B2 | Fe—Si—Cr | 2.5 | 0 | 0.100 | 28.0 | 183 |
| C1 | Fe—Si—Cr | 2.5 | 0.025 | 0 | 31.3 | 182 |
| C2 | Fe—Si—Cr | 2.5 | 0.050 | 0 | 31.6 | 187 |
| C3 | Fe—Si—Cr | 2.5 | 0.100 | 0 | 31.2 | 192 |
| C4 | Fe—Si—Cr | 2.5 | 0.200 | 0 | 31.0 | 200 |
| C5 | Fe—Si—Cr | 2.5 | 0.250 | 0 | 31.3 | 202 |
| C6 | Fe—Si—Cr | 2.5 | 0.500 | 0 | 24.3 | 204 |

As shown in Table 1, Sample A1 is a sample to which the Si-based additive was not added. Samples B1 and B2 are samples produced by using a silane-based coupling agent as the Si-based additive and changing the addition amount of the silane-based coupling agent to each other. Samples C1 to C6 are samples produced by using a Si-containing metal soap as the Si-based additive and changing the addition amount of the Si-containing metal soap. As described above, in the samples shown in Table 1, the heat treatment was not performed in the production of the granulated powder.

As shown in Table 1 and FIG. 5, among the samples using the Si-containing metal soap as the Si-based additive, the samples C1 to C5 in which the addition amount is 0.25 wt % or less have higher magnetic permeability and breakdown voltage than the sample Al in which the Si-based additive is not added. As described above, by adding the Si-containing metal soap, both the magnetic properties and the insulating properties are improved, and both the magnetic properties and the insulating properties can be achieved.

In addition, as compared with the sample Al in which the Si-based additive was not added, in the samples B1 and B2 in which the silane-based coupling agent was used as the Si-based additive, the breakdown voltage was increased and the insulation properties were improved, but the magnetic permeability was decreased and the magnetic properties were deteriorated. In addition, the breakdown voltages of the samples B1 and B2 are smaller than those of the samples C2 and C3 in which the addition amount of the Si-based additive is equivalent. That is, the use of the Si-containing metal soap as the Si-based additive is more effective in improving the insulation properties of the dust core than the use of the silane-based coupling agent.

Since the Si-containing metal soap has a long hydrocarbon chain, the Si-containing metal soap has higher affinity with the resin than the silane-based coupling agent, and the gap between the metal magnetic particles is easily reduced during molding. Therefore, it is considered that the magnetic permeability was improved in the dust core using the Si-containing metal soap. In addition, the Si-containing metal soap is more likely to be present on the surface of the metal magnetic particles than the silane-based coupling agent, for example, the Si-containing metal soap is more likely to form a coating film on the surface of the metal magnetic particles. Therefore, it is considered that the breakdown voltage is easily improved in the dust core using the Si-containing metal soap.

In addition, in the evaluation of samples C1 to C6, the breakdown voltage increases as the addition amount of the Si-containing metal soap increases. It is considered to be because the Si-containing metal soap forms a strong coating film on the surface of the metal magnetic particles, and the coating film becomes stronger as the addition amount increases. In the evaluation of the samples C1 to C6, there was no difference in the magnetic permeability when the addition amount of the Si-containing metal soap was 0.25 wt % or less, but the magnetic permeability decreased in the sample C6 in which the addition amount of the Si-containing metal soap was 0.5 wt %. It is considered that this is because the affinity between the metal magnetic powder and the resin is increased by the effect of the Si-containing metal soap, and the gap between the metal magnetic particles is easily reduced during molding. On the other hand, it is considered that when the addition amount is large, the component derived from the Si-containing metal soap is increased, and the gap between the metal magnetic particles is easily widened.

### Evaluation Result 2

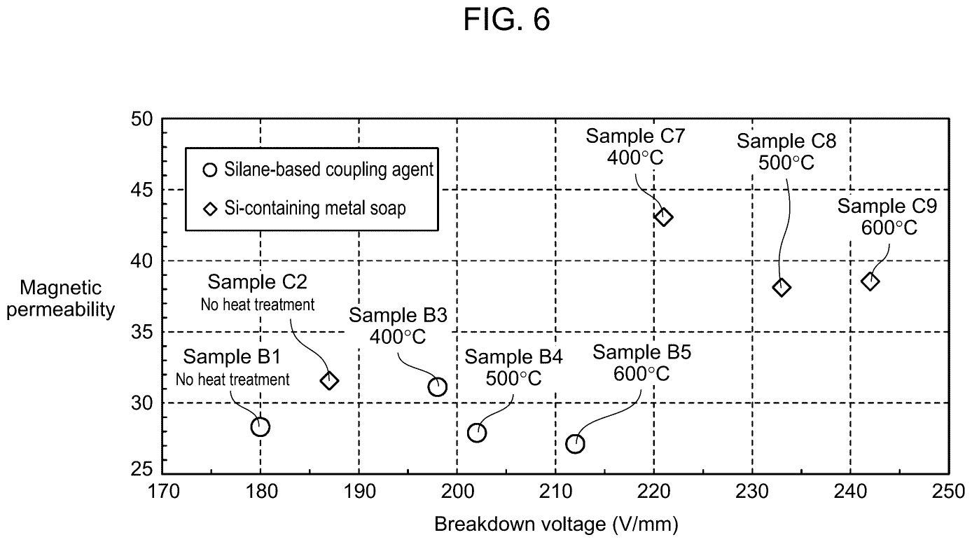

Next, with reference to Table 2 and FIG. 6, a description will be given of results of evaluation of magnetic properties and insulating properties in samples subjected to the heat treatment temperature in the production of the granulated powder.

Table 2 shows the types of the metal magnetic powder, the addition amount of the resin, the kinds and addition amount of the Si-based additive, the heat treatment temperature, the magnetic permeability, and the breakdown voltage of each of the dust core samples used for the evaluation. FIG. 6 is a diagram showing the relationship between the breakdown voltage and the magnetic permeability in the samples shown in Table 2. That is, FIG. 6 is a graph of the data of Table 2. In FIG. 6, the vertical axis represents the magnetic permeability, and the horizontal axis represents the breakdown voltage. Therefore, in FIG. 6, it can be seen that the samples plotted on the upper right are samples that can achieve both magnetic characteristics and insulation properties. In addition, in FIG. 6, the evaluation results of samples B1 and B3 to B5 using only the silane-based coupling agent as the Si-based additive (“Silane-based coupling agent” in the legend in the figure) and the evaluation results of samples C2 and C7 to C9 using only the Si-containing metal soap (“Si-containing metal soap” in the legend in the figure) are indicated by markers having shapes different from each other. Each marker is labeled with a sample identification code and a heat treatment temperature.

TABLE 2

| | | | Addition amount of | | | | |
|---|---|---|---|---|---|---|---|
| | | Addition | Si-based additive | | Heat | | |
| | Metal | amount | (wt %) | | treatment | | Breakdown |
| | magnetic | of resin | Si-containing | Silane-based | temperature | Magnetic | voltage |
| Sample | powder | (wt %) | metal soap | coupling agent | (° C.) | permeability | (V/mm) |
| B1 | Fe—Si—Cr | 2.5 | 0 | 0.050 | No heat | 28.3 | 180 |
| | | | | | treatment | | |
| B3 | Fe—Si | 2.5 | 0 | 0.050 | 400 | 31.1 | 198 |
| B4 | Fe—Si | 2.5 | 0 | 0.050 | 500 | 27.9 | 202 |
| B5 | Fe—Si | 2.5 | 0 | 0.050 | 600 | 27.1 | 212 |
| C2 | Fe—Si—Cr | 2.5 | 0.050 | 0 | No heat | 31.6 | 187 |
| | | | | | treatment | | |
| C7 | Fe—Si | 2.5 | 0.050 | 0 | 400 | 43.1 | 221 |
| C8 | Fe—Si | 2.5 | 0.050 | 0 | 500 | 38.1 | 233 |
| C9 | Fe—Si | 2.5 | 0.050 | 0 | 600 | 38.5 | 242 |

Table 2 also shows the evaluation results of some of the dust core samples shown in Table 1. The same samples as those in Table 1 are denoted by the same identification symbols in Table 2.

As shown in Table 2, samples B3 to B5 are samples fabricated by using a silane-based coupling agent as the Si-based additive in an addition amount of 0.05 wt % and changing the heat treatment temperature. Samples C7 to C9 are samples produced by using a Si-containing metal soap as the Si-based additive in an addition amount of 0.05 wt % and changing the heat treatment temperature. As shown in Table 2, the composition of the metal magnetic powder is different between samples B1 and C2 in which the heat treatment is not performed in the production of the granulated powder and samples B3 to B5 and C7 to C9 in which the heat treatment is performed in the production of the granulated powder.

As shown in Table 2 and FIG. 6, samples C7 to C9 and B3 to B5 subjected to the heat treatment have higher breakdown voltages than samples B1 and C2 not subjected to the heat treatment regardless of the kinds of Si-based additive. The Fe—Si-based magnetic metal powder used in samples B3 to B5 and C7 to C9 subjected to the heat treatment has a property that the insulating property is more likely to be lowered than the Fe—Si—Cr-based magnetic metal powder used in samples B1 and C2 not subjected to the heat treatment. In spite of this, since the breakdown voltage is increased by performing the heat treatment, it can be said that the insulating property is improved by performing the heat treatment. It is considered to be because the Si-based additive is fixed to the surface of the metal magnetic particles by the heat treatment to form a coating film, and the contact of the metal magnetic powder is suppressed.

In addition, when compared in terms of the kinds of the Si-based additive, samples C7 to C9 in which the Si-containing metal soap was used had insulating properties significantly increased by the heat treatment compared to Samples B3 to B5 in which the silane-based coupling agent was used. In addition, the magnetic permeability is increased by the heat treatment in Samples C7 to C9 using the Si-containing metal soap, but is hardly changed even by the heat treatment in Samples B3 to B5 using the silane-based coupling agent. As described above, by performing the heat treatment using the Si-containing metal soap, a dust core having improved magnetic permeability and magnetic properties can be realized. It is considered to be because the Si-containing metal soap having a long hydrocarbon chain is more likely to form a strong coating film on the surface of the metal magnetic particles than the silane-based coupling agent by the heat treatment.

### Summary

From the results of the evaluation of the dust core described above, it was found that the breakdown voltage of the dust core was increased and the insulation properties of the dust core could be improved by mixing the Si-containing metal soap in a liquid state at 25° C. and the metal magnetic powder in the production of the granulated powder. In addition, it was found that by setting the mixing ratio of the Si-containing metal soap to the metal magnetic powder to 0.25 wt % or less, the magnetic permeability was increased, and the magnetic characteristics could be improved in addition to the insulating properties.

In addition, it was found that when the mixture of the Si-containing metal soap and the metal magnetic powder was subjected to heat treatment in the production of the granulated powder, the magnetic permeability and the breakdown voltage were further increased, and the magnetic properties and the insulating properties of the dust core could be further improved.

### Other Embodiments, Etc

Although the dust core according to the embodiment of the present disclosure has been described above, the present disclosure is not limited to this embodiment.

For example, an electrical component using the dust core described above is also included in the present disclosure. Examples of the electrical component include inductance components such as a high-frequency reactor, an inductor, and a transformer. In addition, a power supply device including the above-described electrical component is also included in the present disclosure.

Further, the present disclosure is not limited to the above-described embodiments. Those skilled in the art will readily appreciate that many modifications are possible in the exemplary embodiments without materially departing from the novel teachings and advantages of this disclosure. Accordingly, all such modifications are intended to be included within the scope of this disclosure.

Hereinafter, an example of a method for manufacturing the dust core according to the present disclosure described based on the above embodiment will be described. The method for producing a dust core according to the present disclosure is not limited to the following example.

For example, a method for manufacturing a dust core according to a first aspect of the present disclosure includes: a first step of mixing a metal magnetic powder, a resin, and a metal soap to obtain a granular granulated powder, the metal magnetic powder including a plurality of metal magnetic particles; and a second step of pressure-molding the granular granulated powder obtained, in which the metal soap mixed in the first step is in a liquid state at 25° C. and includes a Si element.

For example, a method for manufacturing a dust core according to a second aspect of the present disclosure is the method for manufacturing the dust core according to the first aspect, wherein in the first step, a mixing ratio of the metal soap to the metal magnetic powder is 0.25 wt % or less.

In addition, for example, a method for manufacturing a dust core according to a third aspect of the present disclosure is the method for manufacturing the dust core according to the first aspect or the second aspect, in which in the first step, a mixture is obtained by mixing the metal magnetic powder and the metal soap, and then the granular granulated powder is obtained by mixing the mixture and the resin.

For example, a method for manufacturing a dust core according to a fourth aspect of the present disclosure is the method for manufacturing the dust core according to the third aspect, wherein in the first step, after the mixture is obtained and before the mixture and the resin are mixed, the mixture is subjected to a heat treatment under a temperature condition of at least 200° C. and at most 800° C.

For example, a method for manufacturing a dust core according to a fifth aspect of the present disclosure is the method for manufacturing the dust core according to the fourth aspect, wherein the temperature condition of the heat treatment is at least 400° C. and at most 600° C.

For example, a method for manufacturing a dust core according to a sixth aspect of the present disclosure is the method for manufacturing the dust core according to the fourth or fifth aspect, wherein in the first step, the heat treatment is performed in a non-oxidizing atmosphere.

### INDUSTRIAL APPLICABILITY

The dust core according to the present disclosure can be applied to a material of a magnetic core of an inductor or a transformer for high frequency.

### REFERENCE MARKS IN THE DRAWINGS

10 dust core
11 Metal magnetic powder
12 Binder
20, 30 Lead portion
25 first terminal member
35 second terminal member
40 coil member
100 Electrical component

1. A method for manufacturing a dust core, the method comprising:
mixing a metal magnetic powder, a resin, and a metal soap to obtain a granular granulated powder, the metal magnetic powder including a plurality of metal magnetic particles; and
pressure-molding the granular granulated powder obtained,
wherein in the mixing, the metal soap is in a liquid state at 25° C. and includes a Si element.

2. The method for manufacturing the dust core according to claim 1,
wherein in the mixing, a mixing ratio of the metal soap to the metal magnetic powder is 0.25 wt % or less.

3. The method for manufacturing the dust core according to claim 1,
wherein in the mixing, the granular granulated powder is obtained by obtaining a mixture of the metal magnetic powder and the metal soap and then mixing the mixture and the resin.

4. The method for manufacturing the dust core according to claim 3,
wherein in the mixing, after the mixture is obtained and before the mixture and the resin are mixed, the mixture is subjected to a heat treatment under a temperature condition of at least 200° C. and at most 800° C.

5. The method for manufacturing the dust core according to claim 4,
wherein a temperature condition of the heat treatment is at least 400° C. and at most 600° C.

6. The method for manufacturing the dust core according to claim 4,
wherein in the mixing, the heat treatment is performed in a non-oxidizing atmosphere.
